(19) United States
(12) Patent Application Publication
(10) Pub. No.: US 2020/0126020 A1
(43) Pub. Date: Apr. 23, 2020

(54) ASSESSING SUITABILITY TO JOIN A CURRENT TEAM OF WORKERS

(71) Applicant: Microsoft Technology Licensing, LLC, Redmond, WA (US)

(72) Inventors: Filip Ferris NICOLAISEN, Tromsø (NO); Johan GRØNVIK, Tromsø (NO); Thomas LUNDE, Tromsø (NO); Ronny JENSEN, Tromsø (NO)

(21) Appl. No.: 16/166,952

(22) Filed: Oct. 22, 2018

(51) Int. Cl. G06Q 10/06

(52) U.S. Cl. CPC G06Q 10/063112

(57) ABSTRACT

A numerical score for each of a plurality of skills is assigned for each current worker of a current team and for one or more candidate workers who are candidates for addition to the current team. Vector spaces of the numerical scores for each current worker and candidate worker team are constructed. From the vector space of skills for the or each current worker and the vector space of skills for the or each candidate worker, a measure of the overlap of the skills of the or each candidate worker with the skills of the or each worker of the current team is obtained. This thereby assesses the suitability of the or each candidate worker to join the current team of one or more workers.

### TECHNICAL FIELD

The present disclosure relates to a computer-implemented method, a computer program and a computer system for assessing suitability of one or more candidate workers to join a current team of one or more workers

### BACKGROUND

There are many situations in which it is necessary to assemble a team of individuals or workers to work on a particular job or task or to work together more generally. Such teams of individuals have historically been put together by one or more individuals, who may be managers or other co-workers of the people concerned, working largely or exclusively by “feel” and with little or no objectivity and with little or no systematic approach.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

According to a first aspect disclosed herein, there is provided a computer-implemented method of assessing suitability of one or more candidate workers to join a current team of one or more workers, the method comprising:

assigning, by one or more processors, a numerical score for each of a plurality of skills for the or each current worker of a current team of one or more workers;

constructing, by one or more processors, a vector space of the numerical scores of the plurality of skills for the or each current worker of the current team;

assigning, by one or more processors, a numerical score for each of the plurality of skills for one or more candidate workers who are candidates for addition to the current team;

constructing, by one or more processors, a vector space of the numerical scores of the plurality of skills for the or each candidate worker who is a candidate for addition to the current team; and

obtaining, by one or more processors, from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.

Examples of the present disclosure enable candidate workers for adding to a current team to be selected based on for example matching skills or complementing skills between the current workers and the candidate workers. This is in contrast to some systems which concern matching skills to the job or task which the team is undertaking or intended to undertake, rather than matching skills or complementing skills of current workers.

In an example:

the constructing the vector space of the numerical scores of the plurality of skills for the or each current worker of the current team comprises forming a matrix in which the elements of the matrix are the numerical scores of the plurality of skills for the or each current worker of the current team, in which the rows of the matrix correspond to the skills and the columns of the matrix correspond to the or each worker or vice versa;

the constructing the vector space of the numerical scores of the plurality of skills for the or each candidate worker who is a candidate for addition to the current team comprises forming a matrix in which the elements of the matrix are the numerical scores of the plurality of skills for the or each candidate worker, in which the rows of the matrix correspond to the skills and the columns of the matrix correspond to the or each worker or vice versa; and

the obtaining a measure of the overlap of the skills of the or each candidate worker with the skills of the or each worker of the current team comprises carrying out, by one or more processors, a matrix multiplication of the transpose of the matrix for the or each current worker with the matrix for the or each candidate worker to produce a product matrix in which the elements of the product matrix represent the measure of the overlap of the skills of the or each candidate worker with the skills of the or each worker of the current team.

In an example, the method comprises, prior to carrying out the matrix multiplication, normalizing, by one or more processors, separately for each skill in each matrix, the numerical scores of the skills for the or each worker, such that the matrix multiplication is performed on normalized matrices for the or each current worker and the or each candidate worker.

In an example, the normalizing the numerical scores of a skill comprises, by one or more processors, identifying the maximum score of said skill for the workers in the matrix and dividing the numerical score of said skill for the or each worker by said maximum score.

In an example, the current team comprises plural workers, the method comprising, prior to carrying out the matrix multiplication, balancing the numerical scores of the skills for each worker in the matrix for the current workers by, for each worker in the matrix for the current workers and by one or more processors, summing the numerical scores of the skills for that worker and dividing the numerical score of each skill for that worker by said sum.

In an example, the method comprises obtaining a measure of the overlap of a candidate worker with the one or more current workers of the current team as the values of the elements in the main diagonal of a matrix formed by matrix multiplication of the transpose of the product matrix with the product matrix.

In an example, the method comprises obtaining the numerical score for at least one of the plurality of skills for at least one of the workers by programmatically extracting data concerning the at least one of the plurality of skills from a database or repository which stores data provided by or relating to said at least one of the workers.

According to a second aspect disclosed herein, there is provided a computer program comprising instructions such that when the computer program is executed on a computing device, the computing device is arranged to carry out a method of assessing suitability of one or more candidate workers to join a current team of one or more workers, the method comprising:

assigning, by one or more processors, a numerical score for each of a plurality of skills for the or each current worker of a current team of one or more workers;

constructing, by one or more processors, a vector space of the numerical scores of the plurality of skills for the or each current worker of the current team;

assigning, by one or more processors, a numerical score for each of the plurality of skills for one or more candidate workers who are candidates for addition to the current team;

constructing, by one or more processors, a vector space of the numerical scores of the plurality of skills for the or each candidate worker who is a candidate for addition to the current team; and

obtaining, by one or more processors, from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.

There may be provided a non-transitory computer-readable storage medium storing a computer program as described above.

According to a third aspect disclosed herein, there is provided a computer system for carrying out a computer-implemented method of assessing suitability of one or more candidate workers to join a current team of one or more workers, the computer system comprising:

at least one processor;

and at least one memory including computer program instructions;

the at least one memory and the computer program instructions being configured to, with the at least one processor, cause the computer system at least to perform a method comprising:

assigning a numerical score for each of a plurality of skills for the or each current worker of a current team of one or more workers;

constructing a vector space of the numerical scores of the plurality of skills for the or each current worker of the current team;

assigning a numerical score for each of the plurality of skills for one or more candidate workers who are candidates for addition to the current team;

constructing a vector space of the numerical scores of the plurality of skills for the or each candidate worker who is a candidate for addition to the current team; and

obtaining from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a computer system for implementing examples described herein; and

FIG. 2 shows schematically a flow chart for an example of a method according to the present disclosure.

### DETAILED DESCRIPTION

As briefly mentioned, there are many situations in which it is necessary to assemble a team of individuals or workers to work on a particular job or task or to work together more generally. For example, a team may be required to work on a large project for an external client or customer or for an internal department of an organization. The project may be one of a large number of different types, including for example and without limitation dealing with HR (human resources) problems, writing or coding a particular software program for a particular task, dealing with a particular customer's request for certain services, developing a new product line, dealing with a fault in a product or machine, etc.

Such teams of individuals have historically been put together by one or more individuals, who for example may be managers or other co-workers of the people concerned. Such managers or the like have historically worked largely or exclusively by “feel”, with little or no objectivity and often with little or no systematic approach. This can lead to inefficiencies in the selection process and to teams that are not optimal. Moreover, this can also give rise to discontent amongst workers who may feel that they have been excluded from a team for improper or incorrect reasons.

Some examples described herein provide a systematic approach, implemented using one or more computers, to allow a team of individuals to be assembled in an efficient way that is more objective and systematic. Different criteria for the team and for adding potential new members to the team can be set to identity the most appropriate new members to be added to the team. The approach can be demonstrably more objective than previous, largely manual approaches, which can be used to give comfort to workers that the selection process has been carried out properly and objectively without bias and that the process fairly represents the different skills of the various workers.

In examples described herein, a numerical score is assigned for each of a number of skills for each current worker of a current team and also for candidate workers who are candidates for addition to the current team. Vector spaces for the numerical scores are constructed. A measure of the overlap of the skills of the or each candidate worker with the skills of the or each worker of the current team is obtained from the vector spaces of skills. This effectively assesses the suitability of the or each candidate worker to join the current team of one or more workers. Some specific examples of the skills and specific examples of techniques and some variations will be discussed in more detail below.

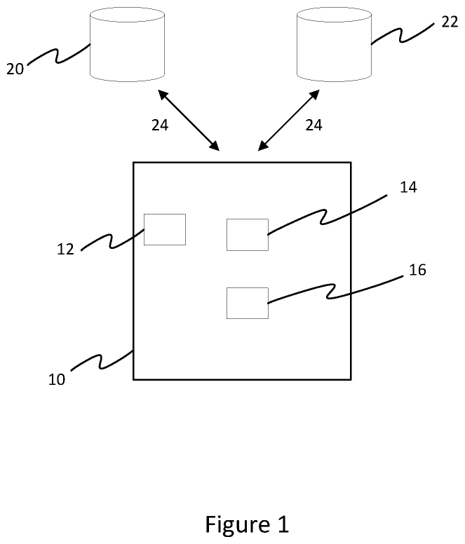

Referring to FIG. 1, this shows schematically an example of a computer system 10. The computer system 10 has one or more processors 12, data storage 14, working memory 16, etc. commonly provided in computing devices. The computer system 10 is in communication with one or more databases 20,22 or other repositories 20,22 of data which may be used in examples. The communication between the computer system 10 and the databases or other data repositories 20,22 may be wired and/or wireless links 24, which may include one or more of a local area network connection and the Internet. In some examples, the computer system 10 itself may include databases 20, 22, stored in for example the local data storage 14 of the computer system 10. The computer system 10 may be used to implement examples of the present disclosure.

In general, a worker may have a number of skills. Correspondingly, a particular job or task or the like for a team of workers requires a certain set of skills of the workers. Commonly, a task may require a number of different skills and a range of skills, and so the team of workers for that task needs to be selected taking that into account. In some cases, the skills of the workers need to complement each other. For example, it may be useful to have one person who is greatly skilled in one area, but may be less skilled in other areas, and to complement that with another person who may be less skilled in the one area but more skilled in one or more of the other areas. In other cases, it may be desirable only to have, or to predominantly only to have, workers who are all highly skilled in a particular area, and diversity of skills across other areas may not be a concern. Examples described herein can be quickly adapted, practically on-the-fly in some examples, to accommodate these different demands of assembling teams for different tasks and different types of tasks.

For example, some specific skills that may be required of workers and which will be discussed further below as a specific example include coding, networking, writing and sustaining. Other skills that may be required of workers, depending on the task, include general skills such as for example experience (measured by say the number of months or years the worker has been working in the field concerned), communicativeness (measured by say the number of conferences or seminars attended by the worker), and teamworking. Other skills that may be required of workers, depending on the task, include more specific skills, such as for example skills in relevant manual tasks (such as certain machining skills, expertise in servicing vehicle engines, etc.), and skills in non-manual tasks (such as experience at a call center, which may be measured by for example the number or proportion of customers who reported a satisfactory experience with the worker).

As noted, in an initial phase of an example of the present disclosure in which one or more candidate workers are assessed for their suitability to join or to be added to a current team of workers, a numerical score is assigned for each of a number of skills for each current worker of the current team. A number of options for assigning the numerical scores are possible. Different ways of assigning scores may apply for different skills, depending on for example the nature of the skill and availability of relevant data for that skill for the particular worker concerned. One option, specific examples of which will be discussed further below, involves programmatically extracting data concerning the skill from a database or repository which stores data provided by or relating to the worker concerned. Advantages of this approach include that it can be fast and efficient. Also, a programmatic approach can be reproduced and can be demonstrably objective, which can be important for workers so that they can be confident that the process for selecting a new team member has been carried out properly and correctly and without deliberate or unconscious bias. If however it is not possible or desirable to assign scores for skills in a programmatic manner, an alternative is to have workers carry out some test or assessment relating to the skills, with the results being used to provide numerical scores to be assigned for the skill. As another alternative, numerical scores may be applied in what may be regarded as a basically manual process based on for example personal knowledge of or experience working with the worker.

Some specific examples of programmatically extracting data concerning a skill from a database or repository will now be discussed. The specific examples of skills discussed here are coding, networking, writing and sustaining, which may be suitable when assembling a team for a task that relates generally to information technology.

Coding here relates generally to a person's skill in writing computer programs. For coding, the numerical score for the coding skill may be some measure of for example the number of computer programs or versions of a computer program that have been written (“coded”) or contributed to by the person concerned. To obtain a measure of this type, the computer system 10 may inspect or interrogate a database or repository 20, 22 that stores computer programs or versions of a computer program that have been written or contributed to by the person concerned, or at least that stores data (“metadata”) concerning computer programs or versions of a computer program that have been written or contributed to by the person concerned. The computer system 10 may for example obtain the number of computer programs or versions of a computer program that have been written by each worker over a certain period of time, such as the last 6 or 12 months, etc.

As a specific example, the number of commits by the worker concerned may be used as a measure of the coding skill and therefore the basis for the numerical score for the coding skill. “Commits” are used in version control systems. In particular, in examples a commit adds the latest changes to the source code of a computer program to the repository, making these changes part of the head revision of the repository. Commits in version control systems are usually kept in the repository indefinitely and thus represent a permanent source of data that can be used in implementing aspects of the present disclosure. As a specific example for implementing this, the Azure DevOps REST (Representational State Transfer) API (Application Programming Interface) by Microsoft Corporation, or some other API or extraction tool, may be used to extract the number of commits per user in the organization for the last year (or since the measurement started). In general, any repository for this may be used. As a specific example, the GitHub repository by GitHub Inc. may be used for this. The GitHub repository is a popular web-based hosting service for version control using Git, which is a version-control system for tracking changes in computer files and coordinating work on those files among multiple people.

Networking here relates generally to a person's ability or desire to interact with other people, for example to exchange information and develop professional or social contacts. As a specific example, networking here may be some measure of how other people regard the person concerned and how they rate that person's interactions. For networking, the numerical score for the networking skill for a person may be some measure of for example the number of contacts the person has, or the ranking of that person by other users. To obtain a measure of this type, the computer system 10 may inspect or interrogate a database or repository 20, 22 that stores data concerning interactions between people.

As a specific example for implementing this, the Microsoft Graph API, or some other API or extraction tool, may be used to extract the most relevant people for each person. In this regard, Microsoft Graph applications can use the People API to retrieve the people who are most relevant to a user. Relevance is determined by the user's communication and collaboration patterns and business relationships. In general, people can be local contacts, contacts from social networking or from an organization's directory, and people from recent communications (such as email and Skype). Along with generating this insight, the People API also provides fuzzy matching search support and the ability to retrieve the list of users relevant to another user in the signed-in user's organization. In a specific example used herein, a numerical value is given for each time a co-worker has the user in question as the most important relevant person, with 10 for most relevant, 9 for second-most relevant, etc., down to the 10th most relevant. Summarizing this across all co-workers gives each co-worker a score for networking.

Writing here relates generally to a person's propensity or tendency to write written material generally (rather than specifically writing computer programs, which is covered by the coding skill discussed above in this example). For writing, the numerical score for the writing skill may be some measure of for example the number of documents written by the user, over a certain period of time, such as the last 6 or 12 months, etc. To obtain a measure of this type, the computer system 10 may inspect or interrogate a database or repository 20, 22 that stores documents that have been for example written or contributed to by the person concerned, or at least that stores data (“metadata”) concerning documents that have been written or contributed to by the person concerned.

As a specific example, the Microsoft Graph API, or some other API or extraction tool, may be used to extract the number of documents in the user's OneDrive as well as on all the Sharepoint Sites he or she is a member of for the last year (or since the measurement started). OneDrive is a file hosting and synchronization service by Microsoft Corporation and is an example of a so-called “cloud-based” file hosting service. SharePoint is a web-based collaborative platform by Microsoft Corporation which acts as a document management and storage system.

Sustaining here relates generally to a person's skill in supporting an organization. In the context of assembling a team for an information technology project, the numerical score for this should relate to a person's skill in supporting an organization in respect of information technology. To obtain a measure of this type, where for example the team relates to software, whether software development or bug-fixing or customer support or the like, the computer system 10 may inspect or interrogate a database or repository 20, 22 that stores data concerning efforts by the user who is supporting the organization in some relevant way.

As a specific example for implementing this, the Azure DevOps REST API by Microsoft Corporation, or some other API or extraction tool, may be used to extract the number of bug-fixes checked in by the worker per day for the last year (or since the measurement started). In general, any repository for this may be used. As a specific example, the GitHub repository by GitHub Inc. may be used for this.

In any event, in this example a set of numerical scores for a number of skills is obtained for each worker of the current team. These scores are conveniently represented in table form. Moreover, presenting these numerical scores in table form facilitates subsequent operations, as will become clear from the following. The scores presented this way form a vector space of the skills, which can be used and manipulated as discussed further below.

At this stage, it is noted that in general the numerical scores for each worker for each skill is a number from zero to a maximum N_max. It is also noted that the maximum score N_max for each skill is likely to be different, and indeed may be very different and may be different by an order of magnitude or more. In an example therefore, the scores for each skill are normalized. This has the advantage that the (normalized) numerical scores are directly comparable. In an example, the scores for each skill for the workers of the current team may be normalized by identifying the maximum score for the skill across the workers of the current team and dividing the individual scores for the skill for the workers of the current team by the respective maximum scores.

This can be seen in the illustrative example below, in which the scores for the skills are presented in table form. Assume that the current team of workers has three workers, Jack, John and Jill. Their “raw” numerical scores for the four skills coding, networking, writing and sustaining are as set out in the table, and, for each skill, the maximum value for that skill is indicated in the rightmost column:

TABLE 1

| | Jack | John | Jill | Maximum |
|---|---|---|---|---|
| Coding | 0 | 23 | 28 | 28 |
| Networking | 4 | 7 | 3 | 7 |
| Writing | 8 | 3 | 3 | 8 |
| Sustaining | 0 | 18 | 15 | 18 |

Dividing each skill-value by its respective maximum yields the following table in which the scores for each skill for each worker are normalized:

TABLE 2

| | Jack | John | Jill |
|---|---|---|---|
| Coding | 0 | 0.821429 | 1 |
| Networking | 0.571429 | 1 | 0.428571 |
| Writing | 1 | 0.375 | 0.375 |
| Sustaining | 0 | 1 | 0.833333 |

These normalized scores for the skills for each worker (in these tables, each worker of the current team) could be used in subsequent phases as they are. However, it is likely that in many cases the skills are not commensurable, that is, are not measured by the same standard, and therefore the scores for the different skills may not be directly comparable. Accordingly, in an example and for at least the current workers of the current team, the normalized scores are balanced for each worker. In a specific example, for each worker of the current team, the normalized scores for the skills for that worker are summed. Following the example above, the sums of the normalized scores for the skills for each worker of the current team are indicated in the bottom row of the following table:

TABLE 3

| | Jack | John | Jill |
|---|---|---|---|
| Coding | 0 | 0.821429 | 1 |
| Networking | 0.571429 | 1 | 0.428571 |
| Writing | 1 | 0.375 | 0.375 |
| Sustaining | 0 | 1 | 0.833333 |
| Sum | 1.571429 | 3.196429 | 2.636905 |

Then, for each worker of the current team, the individual normalized scores for each skill are divided by the sum for that worker, resulting in the following table which sets out the balanced and normalized scores for each worker of the current team:

TABLE 4

| | Jack | John | Jill |
|---|---|---|---|
| Coding | 0 | 0.256983 | 0.379233 |
| Networking | 0.363636 | 0.312849 | 0.162528 |
| Writing | 0.636364 | 0.117318 | 0.142212 |
| Sustaining | 0 | 0.312849 | 0.316027 |

This produces values that show the relative strength of the different skills for each person of the current team. An advantage of this approach is that it assists in demonstrating that the method is fair and objective. This is important for at least the current workers as the current workers can see that the process fairly represents the different skills of the workers of a current team.

When assessing the suitability of one or more candidate workers to be added to the current team, a similar process for obtaining scores for the skills of those candidate workers may be carried out. In particular, in an example, a set of numerical scores for a number of skills is obtained for the or each worker. This may be carried out in accordance with any of the examples for this described above for the workers of the current team or by some other approach. These numerical scores may be presented in table form to form a vector space of the skills. The initial “raw” numerical scores for each skill may be normalized across a plurality of candidate workers. This normalizing may be carried out in a similar manner as described above for the current workers of the current team, namely by identifying the maximum score for the skill across the candidate workers and dividing the individual scores for the skill for the candidate workers by the respective maximum scores. It may not be necessary to balance the scores for the candidate workers as is done for the current workers in an example described above, though this is still an option.

As an illustrative example following on from the specific example discussed above for the current workers (Jack, John and Jill), assume that it is desired to add two more people to the current team. These may be for example other people who are already workers at the organization along with the current team members, or potential new employees of the organization. In any event, assume that two candidate workers Erica and Tom are identified. A table representing their vector skill space for the same skills, after normalizing, may be as follows:

TABLE 5

| | Erica | Tom |
|---|---|---|
| Coding | 0.470447 | 0.02276 |
| Networking | 0.155441 | 0.125521 |
| Writing | 0.897811 | 0.356025 |
| Sustaining | 0.041148 | 0.432754 |

A measure of the overlap of the skills of the or each candidate worker with the skills of the or each worker of the current team is now obtained. This assesses the suitability of the or each candidate worker to join the current team of one or more workers.

For this, in an example the table of (normalized and balanced) scores for skills for each worker of the current team and the table of (normalized) scores for skills for each candidate worker are treated as matrices. These tables/matrices are multiplied to produce a product or “overlap” matrix in which the elements of the overlap matrix represent the overlap in the skill set of each candidate worker with each current worker.

For this, it is recalled that a matrix A is an m-by-n matrix where m is the number of rows and n is the number of columns. Further, the transpose of an m-by-n matrix A is the n-by-m matrix A^{T} formed by turning rows into columns and vice versa. That is, (A^{T})_{i,j}=A_{j,j}, where A_{j,i} is the element at row j and column i of matrix A. Finally, for matrix multiplication, the number of columns of the first (left side) matrix must be equal to the number of rows of the second (right side) matrix. In matrix multiplication, if A is an m-by-n matrix and B is an n-by-p matrix, then their matrix product C=AB is an m-by-p matrix. The matrix C is given by the dot product of the corresponding row of A and the corresponding column of B. That is: C_{i,j}=A_{i,1}B_{1,j}+A_{i,2}B_{2,j}+ . . . +A_{i,n}B_{n,j}=Σᵣ₌₁ⁿA_{i,r}B_{r,j} where X_{i,j} is the value of the element at row i, column k of the matrix X.

With this in mind, in an example to obtain a measure of the overlap of the skills of the or each candidate worker with the skills of the or each worker of the current team, the transpose of the matrix of (normalized and balanced) scores for skills for each worker of the current team is multiplied by the matrix of (normalized) scores for skills for each candidate worker. That is, if A is the matrix of (normalized and balanced) scores for skills for each worker of the current team and B is the matrix of (normalized) scores for skills for each candidate worker, a product matrix C is obtained as:

A^{T}×B=C

Following the illustrative example above, the matrix A corresponds to Table 4 and the matrix B corresponds to Table 5 above. In this example, the product matrix C is:

TABLE 6

| | Erica | Tom |
|---|---|---|
| Jack | 0.627859 | 0.2722054 |
| John | 0.287729 | 0.2222728 |
| Jill | 0.344356 | 0.2164250 |

In this product matrix, or overlap table, by way of example the scalar value at position (1,1) corresponds to the overlap in Jack's and Erica's skill sets, while position (3,2) is Jill's overlap with Tom, where the first index is the row and the second is the column.

Accordingly, the product of the matrices as discussed provides a measure of the overlap of the skills of each candidate worker with the skills of each worker of the current team. It is emphasized that in this example, this comparison is objective (subject only possibly to how the numerical scores for the skills are obtained in the first place) and is reproducible, and can be shown to current and candidate workers if necessary or desirable.

Having obtained this measure of the overlap of the respective skill sets, further processing may be carried out in order to determine which of the candidate workers is the most appropriate to be added to the current team. The criteria for this selection process may be set depending on the goal to be achieved. For example, it may be desirable to maximize the diversity of skill sets across the workers for the team (so that for example the team as a whole is well equipped to deal with a wide range of problems arising from the task). This in turn implies minimizing the overlap of skill sets across the workers for the team. At the other extreme, it may be desirable to minimize the diversity of skill sets across the workers for the team (so that for example the whole team tends to be focused on one particular task or aspect of a task that requires one specific skill), which in turn implies maximizing the overlap of skill sets across the workers for the team.

In an example, the product matrix C (that is, the overlap Table 6 in the specific example) discussed above may be used. In particular, the product C^{T}×C may be taken to result in what may be termed an overlap matrix. It may be noted that the product C^{T}×C results in an overlap matrix for the candidate workers, which in general is required as the decision that is being made is which candidate worker(s) should be added to the current team.

Following the illustrative example above, the product C^{T}×C is:

TABLE 7

| | Erica | Tom |
|---|---|---|
| Erica | 0.595575 | 0.309388 |
| Tom | 0.309388 | 0.170341 |

The values on the main diagonal (from top left to bottom right) of this overlap matrix provide what may be termed the overlap values for the candidate workers. That is, in this illustrative example, the overlap value for Erica is 0.595575 and the overlap value for Tom is 0.170341. If it is desired to add a candidate worker to maximize the diversity of skill sets (so that for example they bring expertise in skills that are underrepresented in the current team), then the candidate with the smallest overlap value is selected, which is Tom in this example. On the other hand, if it is desired to add a candidate worker to maximize the overlap of skill sets, then the candidate with the largest overlap value is selected, which is Erica in this example.

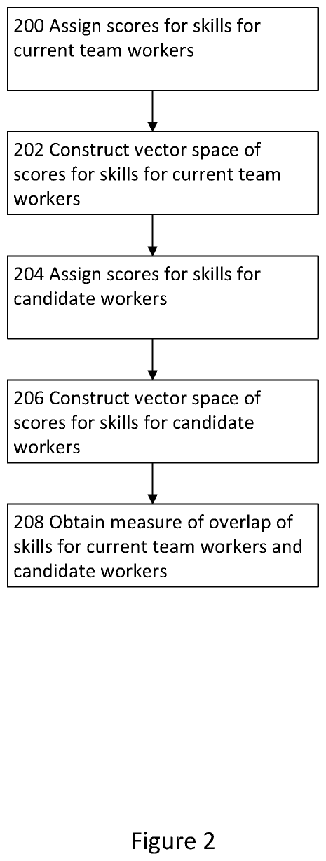

Referring to FIG. 2, this shows schematically a flow chart for an example of a method according to the present disclosure.

At 200, scores for the skills of workers for the current team are assigned. Such scores may be obtained programmatically, as discussed in more detail above. At 202, a vector space for the scores for the skills of workers for the current team is constructed. In an example, a table or matrix of the scores may be constructed.

At 204, scores for the skills of workers who are candidates to be added to the current team are assigned. Such scores may be obtained programmatically, as discussed in more detail above. At 206, a vector space for the scores for the skills of the candidate workers. In an example, again a table or matrix of the scores may be constructed.

At 208, a measure of the overlap of the skills of the current team workers and the skills of the candidate workers is obtained. This may be obtained by a matrix multiplication, as discussed in more detail above.

In addition to use in selecting new workers to join a current team, assigning numerical scores to skills for workers enables further options. For example, the straightforward representation of scores for the skills allows for analysis on the relative competitiveness of a team of workers. This also provides an independent measure for increasing competency in desired fields as it can be quickly seen which skills in the team score lowly and therefore need improving. A manager can also track an employee's relative skills for, for example, measuring increase in competence over time. In addition, the system can generate tags for users who for example supersede a threshold in each skill, which may be regarded as a “super” tag. As another specific example, the system can generate tags for users who have a balanced skill set (for example, having a similar score for each skill in a balanced and normalized table of scores) which may be regarded as an “all-rounder” tag. Such tags may be used for a positive feedback system for the workers.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (e.g. a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

What is claimed is:

1. A computer-implemented method of assessing suitability of one or more candidate workers to join a current team of one or more workers, the method comprising:
assigning, by one or more processors, a numerical score for each of a plurality of skills for the or each current worker of a current team of one or more workers;
constructing, by one or more processors, a vector space of the numerical scores of the plurality of skills for the or each current worker of the current team;
assigning, by one or more processors, a numerical score for each of the plurality of skills for one or more candidate workers who are candidates for addition to the current team;
constructing, by one or more processors, a vector space of the numerical scores of the plurality of skills for the or each candidate worker who is a candidate for addition to the current team; and
obtaining, by one or more processors, from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.

2. A method according to claim 1, wherein:
the constructing the vector space of the numerical scores of the plurality of skills for the or each current worker of the current team comprises forming a matrix in which the elements of the matrix are the numerical scores of the plurality of skills for the or each current worker of the current team, in which the rows of the matrix correspond to the skills and the columns of the matrix correspond to the or each worker or vice versa;
the constructing the vector space of the numerical scores of the plurality of skills for the or each candidate worker who is a candidate for addition to the current team comprises forming a matrix in which the elements of the matrix are the numerical scores of the plurality of skills for the or each candidate worker, in which the rows of the matrix correspond to the skills and the columns of the matrix correspond to the or each worker or vice versa; and
the obtaining a measure of the overlap of the skills of the or each candidate worker with the skills of the or each worker of the current team comprises carrying out, by one or more processors, a matrix multiplication of the transpose of the matrix for the or each current worker with the matrix for the or each candidate worker to produce a product matrix in which the elements of the product matrix represent the measure of the overlap of the skills of the or each candidate worker with the skills of the or each worker of the current team.

3. A method according to claim 2, comprising, prior to carrying out the matrix multiplication, normalizing, by one or more processors, separately for each skill in each matrix, the numerical scores of the skills for the or each worker, such that the matrix multiplication is performed on normalized matrices for the or each current worker and the or each candidate worker.

4. A method according to claim 3, wherein the normalizing the numerical scores of a skill comprises, by one or more processors, identifying the maximum score of said skill for the workers in the matrix and dividing the numerical score of said skill for the or each worker by said maximum score.

5. A method according to claim 2, wherein the current team comprises plural workers, the method comprising, prior to carrying out the matrix multiplication, balancing the numerical scores of the skills for each worker in the matrix for the current workers by, for each worker in the matrix for the current workers and by one or more processors, summing the numerical scores of the skills for that worker and dividing the numerical score of each skill for that worker by said sum.

6. A method according to claim 2, comprising obtaining a measure of the overlap of a candidate worker with the one or more current workers of the current team as the values of the elements in the main diagonal of a matrix formed by matrix multiplication of the transpose of the product matrix with the product matrix.

7. A method according to claim 1, comprising obtaining the numerical score for at least one of the plurality of skills for at least one of the workers by programmatically extracting data concerning the at least one of the plurality of skills from a database or repository which stores data provided by or relating to said at least one of the workers.

8. A non-transitory computer-readable storage medium storing a computer program comprising instructions such that when the computer program is executed on a computing device, the computing device is arranged to carry out a method of assessing suitability of one or more candidate workers to join a current team of one or more workers, the method comprising:
assigning, by one or more processors, a numerical score for each of a plurality of skills for the or each current worker of a current team of one or more workers;
constructing, by one or more processors, a vector space of the numerical scores of the plurality of skills for the or each current worker of the current team;
assigning, by one or more processors, a numerical score for each of the plurality of skills for one or more candidate workers who are candidates for addition to the current team;
constructing, by one or more processors, a vector space of the numerical scores of the plurality of skills for the or each candidate worker who is a candidate for addition to the current team; and
obtaining, by one or more processors, from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.

9. A non-transitory computer-readable storage medium according to claim 8, wherein the instructions are such that:
the constructing the vector space of the numerical scores of the plurality of skills for the or each current worker of the current team comprises forming a matrix in which the elements of the matrix are the numerical scores of the plurality of skills for the or each current worker of the current team, in which the rows of the matrix correspond to the skills and the columns of the matrix correspond to the or each worker or vice versa;
the constructing the vector space of the numerical scores of the plurality of skills for the or each candidate worker who is a candidate for addition to the current team comprises forming a matrix in which the elements of the matrix are the numerical scores of the plurality of skills for the or each candidate worker, in which the rows of the matrix correspond to the skills and the columns of the matrix correspond to the or each worker or vice versa; and
the obtaining a measure of the overlap of the skills of the or each candidate worker with the skills of the or each worker of the current team comprises carrying out, by one or more processors, a matrix multiplication of the transpose of the matrix for the or each current worker with the matrix for the or each candidate worker to produce a product matrix in which the elements of the product matrix represent the measure of the overlap of the skills of the or each candidate worker with the skills of the or each worker of the current team.

10. A non-transitory computer-readable storage medium according to claim 9, wherein the instructions are such that the method comprises, prior to carrying out the matrix multiplication, normalizing, by one or more processors, separately for each skill in each matrix, the numerical scores of the skills for the or each worker, such that the matrix multiplication is performed on normalized matrices for the or each current worker and the or each candidate worker.

11. A non-transitory computer-readable storage medium according to claim 10, wherein the instructions are such that the normalizing the numerical scores of a skill comprises, by one or more processors, identifying the maximum score of said skill for the workers in the matrix and dividing the numerical score of said skill for the or each worker by said maximum score.

12. A non-transitory computer-readable storage medium according to claim 9, wherein the instructions are such that, where the current team comprises plural workers, the method comprises, prior to carrying out the matrix multiplication, balancing the numerical scores of the skills for each worker in the matrix for the current workers by, for each worker in the matrix for the current workers and by one or more processors, summing the numerical scores of the skills for that worker and dividing the numerical score of each skill for that worker by said sum.

13. A non-transitory computer-readable storage medium according to claim 9, wherein the instructions are such that the method comprises obtaining a measure of the overlap of a candidate worker with the one or more current workers of the current team as the values of the elements in the main diagonal of a matrix formed by matrix multiplication of the transpose of the product matrix with the product matrix.

14. A non-transitory computer-readable storage medium according to claim 8, wherein the instructions are such that the method comprises obtaining the numerical score for at least one of the plurality of skills for at least one of the workers by programmatically extracting data concerning the at least one of the plurality of skills from a database or repository which stores data provided by or relating to said at least one of the workers.

15. A computer system for carrying out a computer-implemented method of assessing suitability of one or more candidate workers to join a current team of one or more workers, the computer system comprising:
at least one processor;
and at least one memory including computer program instructions;
the at least one memory and the computer program instructions being configured to, with the at least one processor, cause the computer system at least to perform a method comprising:
assigning a numerical score for each of a plurality of skills for the or each current worker of a current team of one or more workers;
constructing a vector space of the numerical scores of the plurality of skills for the or each current worker of the current team;
assigning a numerical score for each of the plurality of skills for one or more candidate workers who are candidates for addition to the current team;
constructing a vector space of the numerical scores of the plurality of skills for the or each candidate worker who is a candidate for addition to the current team; and
obtaining from the vector space of skills for the or each current worker and the vector space of skills for the or each candidate worker, a measure of the overlap of the skills of the or each candidate worker with the skills of the or each worker of the current team, thereby assessing the suitability of the or each candidate worker to join the current team of one or more workers.
